(19) United States
(12) Patent Application Publication
(10) Pub. No.: US 2013/0152006 A1
(43) Pub. Date: Jun. 13, 2013

(54) ELECTRONIC DEVICE CAPABLE OF SIMULATING PAGE FLIP EFFECT

(71) Applicants: LING-JUAN JIANG, Shenzhen City (CN); CHIH-SAN CHIANG, Tu-Cheng (TW); HAI-SEN LIANG, Shenzhen City (CN); JI LI, Shenzhen City (CN); HUA-DONG CHENG, Shenzhen City (CN); HAN-CHE WANG, Tu-Cheng (TW)

(72) Inventors: LING-JUAN JIANG, Shenzhen City (CN); CHIH-SAN CHIANG, Tu-Cheng (TW); HAI-SEN LIANG, Shenzhen City (CN); JI LI, Shenzhen City (CN); HUA-DONG CHENG, Shenzhen City (CN); HAN-CHE WANG, Tu-Cheng (TW)

(21) Appl. No.: 13/660,975

(22) Filed: Oct. 25, 2012

(30) Foreign Application Priority Data
Dec. 12, 2011 (CN) 201110411722.2

(51) Int. Cl. G06F 3/048

(52) U.S. Cl. 715/776

(57) ABSTRACT

An electronic device capable of simulating page flip effect includes an input unit, a display unit, a page flip control module and a thickness control module. The input unit generates a flip-page instruction in response to a user's operation. The display unit displays an electronic document in a page flipping format which includes a currently displayed page and a margin portion adjacent to the currently displayed page, and the margin portion includes a plurality of displayed stacked margins of undisplayed pages. The margins cooperatively resemble a thickness of the undisplayed pages. The page flip control module flips the currently displayed page over in response to the flip-page instruction to display a page flipping effect on the display unit. The thickness control module adds or removes a margin displayed in the margin portion, in response to the flip-page instruction to present a variation of the thickness of the undisplayed pages accordingly.

### BACKGROUND

1. Technical Field

The present disclosure relates to electronic devices, and particularly to an electronic device capable of simulating page flip effect.

2. Description of Related Art

Nowadays, many electronic devices, e.g., mobile phones, digital photo frames, electronic readers, are capable of storing and displaying electronic documents (e.g., digital images, digital texts, etc). Readability of these electronic devices can deviate greatly from a hardcopy paper. For example, when people flip a page of an electronic document on these electronic devices, the page is directly changed without any visual effect simulating the turning of a page; as a result, it is difficult for people to achieve the experience of reading a hardcopy paper.

To resolve this problem, software capable of generating a page flip effect when flipping through the pages of the digital document is introduced. However, a powerful processing unit is needed to run the software, which results in increase of the cost of these electronic devices.

Therefore, it is necessary to provide an electronic device to overcome the above-identified deficiencies.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electronic device capable of simulating page flip effect, according to a first embodiment.

FIG. 2 is a schematic diagram illustrating a page flip effect of an electronic document displayed in the electronic device, according to the first embodiment.

FIG. 3 is a schematic diagram illustrating a margin size parameter table, according to the first embodiment.

FIG. 4 is a schematic diagram illustrating a “]” shaped line representing a margin of the electronic document of FIG. 2, according to a second embodiment.

FIG. 5 is a schematic diagram illustrating a strip-shaped rectangle representing a margin of the electronic document of FIG. 2, according to a third embodiment.

FIG. 6 is a schematic diagram illustrating a rectangular frame representing a margin of the electronic document of FIG. 2, according to a forth embodiment.

FIG. 7 is a schematic diagram illustrating an electronic document displayed in the electronic device, according to a fifth embodiment.

FIG. 8 is a schematic diagram illustrating an “L” shaped line representing a margin of the electronic document of FIG. 7, according to a sixth embodiment.

FIG. 9 is a schematic diagram illustrating an “L” shaped elongated rectangle representing a margin of the electronic document of FIG. 7, according to a seventh embodiment.

FIG. 10 is a schematic diagram illustrating an electronic document displayed in the electronic device, according to an eighth embodiment.

### DETAILED DESCRIPTION

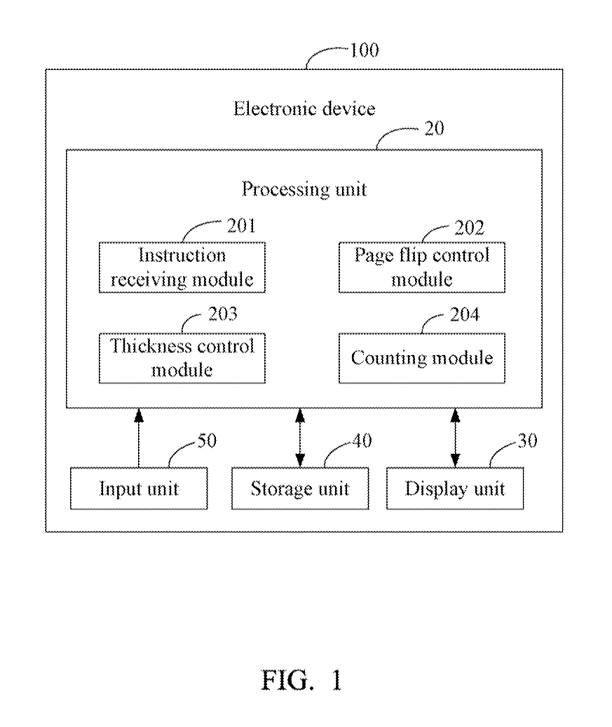

Referring to FIG. 1, an electronic device 100 capable of simulating page flip effect is provided. The electronic device 100 includes but not limited to a mobile phone, an e-reader, a digital photo frame, for example. The electronic device 100 includes a processing unit 20, a display unit 30, a storage unit 40 and an input unit 50. The input unit 50 is configured to generate a flip-page instruction in response to a user's operation.

The processing unit 20 includes an instruction receiving module 201, a page flip control module 202, a thickness control module 203, and a counting module 204. The instruction receiving module 201 is configured to receive the flip-page instruction generated by the input unit 50. The page flip control module 202 is configured to flip a currently displayed page over, in response to the flip-page instruction to display a page flipping effect on the display unit 30.

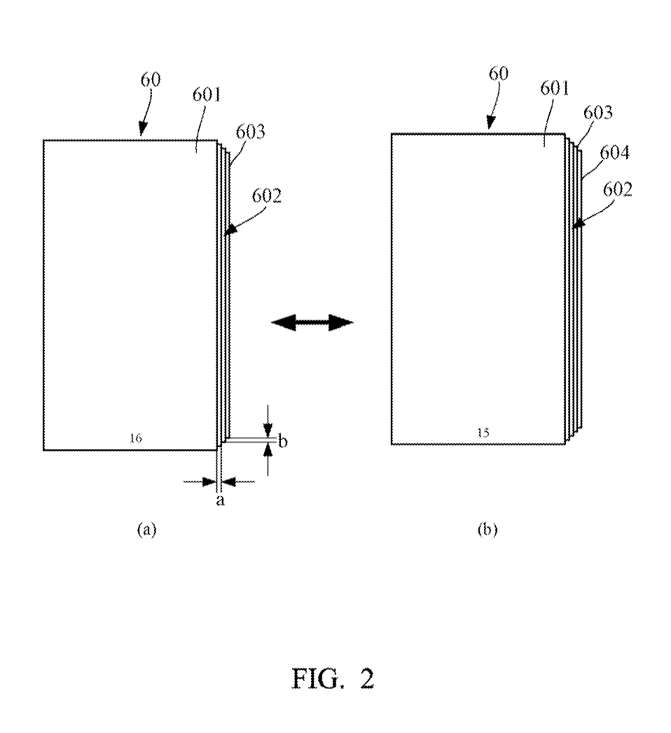

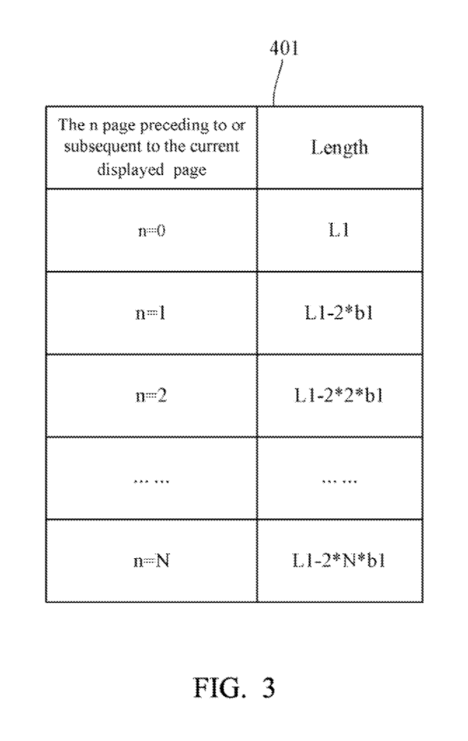

In the embodiment, the storage unit 40 is configured to store electronic documents, a length parameter, a thickness parameter, a margin size parameter table 401 (as shown in FIG. 3). Referring to FIG. 2, the display unit 30 displays an electronic document 60 in a page flipping format, the page flipping format includes the currently displayed page 601 and a margin portion 602 adjacent to the currently displayed page 601. The margin portion 602 includes a number of displayed stacked margins 603 of undisplayed pages. The margins 603 cooperatively resemble a thickness of the undisplayed pages.

In a first embodiment, the margins portion 602 is displayed on the right side of the currently displayed page 601, and includes a number of displayed margins 603 of undisplayed pages subsequent to the currently displayed page 601, and the size of the margins 603 decreases gradually from the margin nearest to the currently displayed page 601 to the margin furthest to the currently displayed page 601.

The table 401 contains a margin length of the currently displayed page and margin lengths of the undisplayed pages. For example, referring also to FIG. 3, the table 401 contains a margin length of the currently displayed page and a margin length of each undisplayed page subsequent to the currently displayed page 601. The margin length of the currently displayed page 601 is symbolically denominated as L1, the length parameter is symbolically denominated as b1, and the thickness parameter is symbolically denominated as a1. In the first embodiment, the margin length of the first undisplayed page subsequent to the currently displayed page is L1−2*b1, the margin length of the Nth undisplayed page subsequent to the currently displayed page is L−2*N*b1. The margins of the undisplayed pages are spaced by a spacing associated with the thickness parameter a1, two ends of the margins of the undisplayed pages are paced by a spacing associated with the length parameter b1 respectively.

The thickness control module 203 is configured to add or remove a margin displayed in the margin portion 602, in response to the flip-page instruction, so as to present a variation of the thickness of the undisplayed pages accordingly. In the first embodiment, the margin which is added or removed by the thickness control module 203 is a margin furthest to the currently displayed page 601.

Specifically, referring to FIG. 2(a), if a page-up instruction is received, the page flip control module 202 controls the display unit 30 to replace the currently displayed page 601 with a previous page, and the thickness control module 203 adds a margin 604 adjacent to the margin furthest to the current displayed page 601, such as what shown in FIG. 2(b). In the first embodiment, the counting module 204 records an amount of the margins, and the thickness control module 203 controls the display unit 30 to display the added margin 604 with a corresponding length according to the recorded amount and the margin lengths defined in the table 401. Conversely, if a page-down instruction is received, the page flip control module 202 controls the display unit 30 to replace the currently displayed page 601 with a rear page, and the thickness control module 203 removes the margin furthest to the currently displayed page 601.

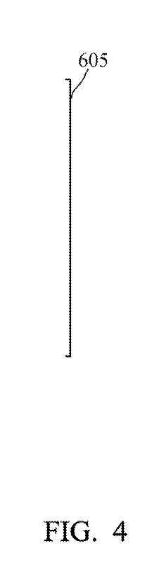

Referring to FIG. 4, in a second embodiment, each of the margins is represented using a “]” shaped line 605. The thickness control module 203 adds or removes the “]” shaped line in response to the flip-page instruction, to display a page flipping effect on the display unit 30. In the second embodiment, the store unit 40 further stores a color parameter. If a page-up instruction is received, the thickness control module 203 further fills color matching the color parameter into the area surrounded by the added line 605 after the line 605 being added. Conversely, if a page-down instruction is received, the thickness control module 203 further removes the color filled in the area previously surrounded by the removed line 605 after the line 605 is removed.

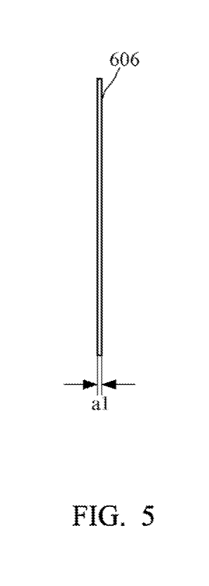

Referring to FIG. 5, in a third embodiment, each of the margins is represented using a strip-shaped rectangle 606 filled with color matching the color parameter. In the third embodiment, the width of each rectangle 606 is defined to be a thickness parameter a1.

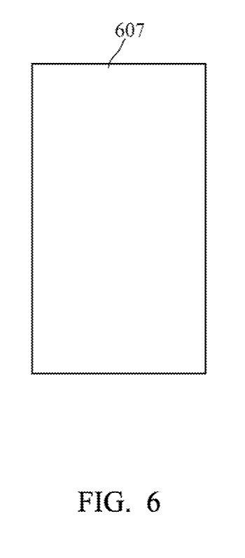

Referring to FIG. 6, in a forth embodiment, each of the undisplayed pages preceding to or subsequent to the currently displayed page is represented using a rectangular frames 607 filled with color matching the color parameter.

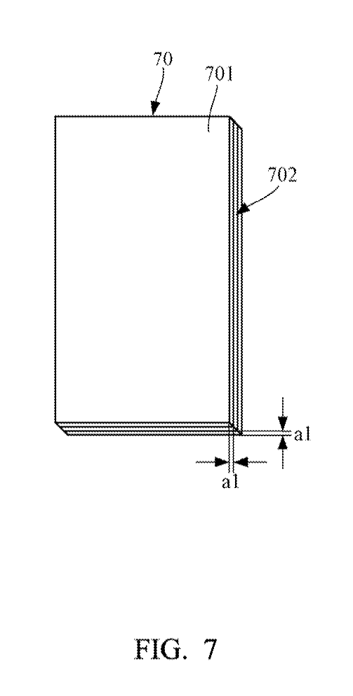

Referring to FIG. 7, in a fifth embodiment, the margin portion 702 includes a number of margins displayed on the right side of the currently displayed page 701 and under the currently displayed page 701.

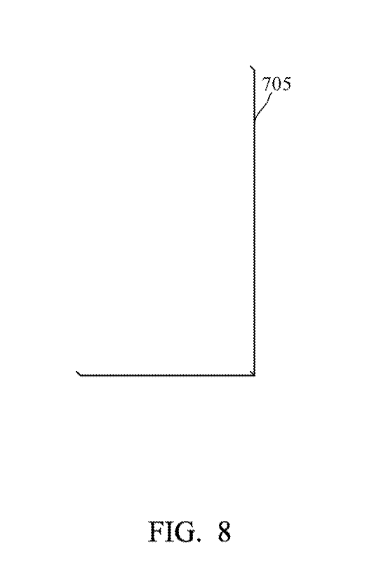

Referring to FIG. 8, in a sixth embodiment, each of the margins is represented using an “L” shaped line 705.

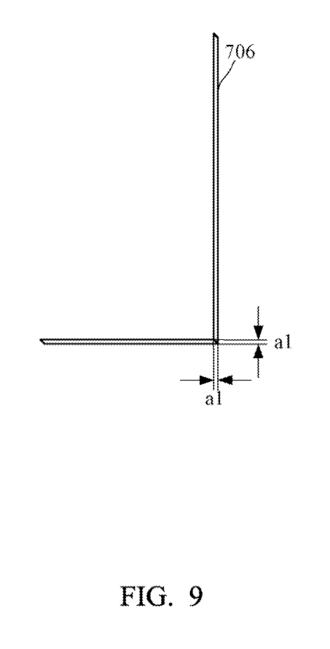

Referring to FIG. 9, in a seventh embodiment, each of the margins is represented using an “L” shaped elongated rectangle 706 filled with color matching the color parameter. In the seventh embodiment, the width of each elongated rectangle 706 is defined to be a thickness parameter a1.

It should be noted that, in another embodiment, the display unit 30 can displays the electronic document 70 with the margins portion 702 displayed on the left side of the currently displayed page 701, under the currently displayed page 701, or above the currently displayed page 701.

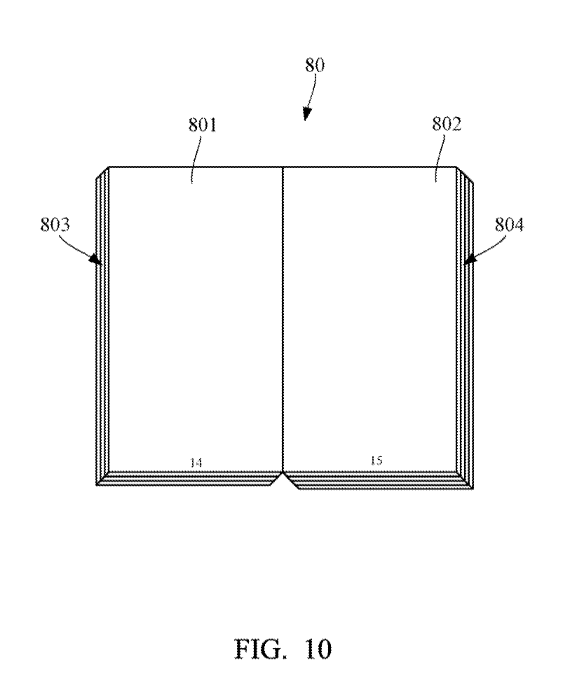

Referring to FIG. 10, in an eighth embodiment, the display unit 30 displays the electronic document 80 in a page flipping format, and the page flipping format includes a first currently displayed page 801, a second currently displayed page 802 subsequent to the first currently displayed page 801, a first margin portion 803 adjacent to the first currently displayed page 801, and a second margin portion 804 adjacent to the second currently displayed page 802. The first margin portion 803 includes a number of displayed stacked margins of undisplayed pages preceding to the first currently displayed page 801, and the margins of the first margin portion 803 cooperatively resemble a thickness of the undisplayed pages preceding to the first currently displayed page 801. The second margin portion 804 comprises a number of displayed stacked margins of undisplayed pages subsequent to the second currently displayed page 802, and the margins of the second margin portion 804 cooperatively resemble a thickness of the undisplayed pages subsequent to the second currently displayed page 802.

As users cannot feel the variation of the thickness of the electronic document when they flip pages, if the margin portion 602 (or 702, 803, 804) indicates a large number of pages, therefore, in another embodiment, the thickness control module 203 adds or removes a margin only when a particular limited number of pages, such as 5 pages, is left behind (or before) the currently displayed page.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device capable of simulating page flip effect, the electronic device comprising:
an input unit configured to generate a flip-page instruction in response to a user's operation;
a display unit configured to display an electronic document in a page flipping format, the page flipping format including a currently displayed page and a margin portion adjacent to the currently displayed page, wherein the margin portion comprises a plurality of displayed stacked margins of undisplayed pages, the margins configured to cooperatively resemble a thickness of the undisplayed pages;
a processing unit comprising:
an instruction receiving module configured to receive the flip-page instruction;
a page flip control module configured to flip the currently displayed page over in response to the flip-page instruction, to display a page flipping effect on the display unit; and
a thickness control module configured to add or remove a margin displayed in the margin portion in response to the flip-page instruction, so as to present a variation of the thickness of the undisplayed pages accordingly.

2. The electronic device as described in claim 1, wherein the margin which is added or removed by the thickness control module is a margin furthest to the currently displayed page.

3. The electronic device as described in claim 1, further comprising a storage unit configured to store a thickness parameter, the margins of the undisplayed pages are spaced by a spacing associated with the thickness parameter.

4. The electronic device as described in claim 1, wherein the size of the margins decreases gradually from the margin nearest to the currently displayed page to the margin furthest to the currently displayed page.

5. The electronic device as described in claim 1, further comprising a storage unit configured to store a margin size parameter table, the table contains a margin length of the currently displayed page and margin lengths of the undisplayed pages.

6. The electronic device as described in claim 1, wherein each of the margins is represented using a “]” shaped line.

7. The electronic device as described in claim 1, wherein each of the margins is represented using a strip-shaped rectangle.

8. The electronic device as described in claim 1, wherein each of the margins is represented using an “L” shaped line.

9. The electronic device as described in claim 1, wherein each of the margins is represented using an “L” shaped elongated rectangle.

10. An electronic device capable of simulating page flip effect, the electronic device comprising:
an input unit configured to generate a flip-page instruction in response to a user's operation;
a display unit configured to display an electronic document in a page flipping format, the page flipping format including a first currently displayed page, a second currently displayed page subsequent to the first currently displayed page, a first margin portion adjacent to the first currently displayed page, and a second margin portion adjacent to the second currently displayed page, wherein the first margin portion comprises a plurality of displayed stacked margins of undisplayed pages preceding to the first currently displayed page, the margins of the first margin portion configured to cooperatively resemble a thickness of the undisplayed first pages preceding to the first currently displayed page, the second margin portion comprises a plurality of displayed stacked margins of undisplayed pages subsequent to the second currently displayed page, the margins of the second margin portion configured to cooperatively resemble a thickness of the undisplayed pages subsequent to the second currently displayed page;
a processing unit comprising:
an instruction receiving module configured to receive the flip-page instruction;
a page flip control module configured to flip the first or the second currently displayed pages over in response to the flip-page instruction, to display a page flipping effect on the display unit; and
a thickness control module configured to add or remove a margin displayed in the first or the second margin portion in response to the flip-page instruction, so as to present a variation of the thickness of the undisplayed first and second pages accordingly.

11. The electronic device as described in claim 10, wherein the margin which is added or removed by the thickness control module is a margin furthest to the first or the second currently displayed page.

12. The electronic device as described in claim 10, further comprising a storage unit configured to store a thickness parameter, the margins of the undisplayed first and second pages are spaced by a spacing associated with the thickness parameter.

13. The electronic device as described in claim 10, wherein each of the margins is represented using a “]” shaped line.

14. The electronic device as described in claim 10, wherein each of the margins is represented using a strip-shaped rectangle.

15. The electronic device as described in claim 10, wherein each of the margins is represented using an “L” shaped line.

16. The electronic device as described in claim 10, wherein each of the margins is represented using an “L” shaped elongated rectangle.
